(19) United States
(12) Patent Application Publication
(10) Pub. No.: US 2023/0002636 A1
(43) Pub. Date: Jan. 5, 2023

(54) UV COATING FOR DIELECTRIC INSULATION

(71) Applicant: LORD Corporation, Cary, NC (US)

(72) Inventors: Ross Zambanini, Raleigh, NC (US); Emmanuel Pitia, Erie, PA (US)

(21) Appl. No.: 17/781,340

(22) PCT Filed: Dec. 9, 2020
(86) PCT No.: PCT/US2020/064022

§ 371 Date: May 31, 2022

Related U.S. Application Data
(60) Provisional application No. 62/945,322, filed on Dec. 9, 2019.

(51) Int. Cl. C09D 175/16; H01M 50/121; H01M 50/122; H01M 50/124; H01M 50/133; H01M 50/119; H01M 10/653; B05D 3/06; C09D 7/62; C08G 18/10; C08K 13/06

(52) U.S. Cl. CPC C09D 175/16; H01M 50/121; H01M 50/122; H01M 50/1245; H01M 50/133; H01M 50/119; H01M 10/653; B05D 3/067; C09D 7/62; C08G 18/10; C08K 13/06; H01M 2220/20; C08K 2003/328

(57) ABSTRACT

A UV curable dielectric coating is described. The curable coating can include one of more acrylate monomers, a urethane prepolymer, a crosslinker, at least one adhesion promoter, a photoinitiator, and optionally one or more fillers and/or additives. The coating can be used to insulate battery cells and battery packs, such as those used in electric vehicles. The coatings can be easily applied and quickly cured. The cured coatings can have high adhesion strength, even after exposure to wet conditions.

### CROSS-REFERENCE TO RELATED APPLICATION

This application claims priority to U.S. Provisional Patent Application Ser. No. 62/945,322 filed Dec. 9, 2019, the disclosure of which is incorporated herein by reference in its entirety.

### TECHNICAL FIELD

The subject matter disclosed herein relates to ultra-violet (UV) radiation curable insulative coatings, particularly UV curable coatings for dielectric insulation of battery packs and methods of applying such coatings.

### BACKGROUND

In electric vehicle battery packs and other types of battery packs, components such as individual battery cells, side walls, cooling plates and other devices are electrically insulated from other components to prevent short circuiting, thus improving the safety and durability of battery packs. Current processes of electrically insulating these components include powder coating or the use of polyethylene terephthalate (PET) film coatings. While powder coating is a common process, it typically requires high temperatures and a longer cure time. Since batteries are not generally compatible with these high temperatures, powder coating is traditionally limited to non-battery hardware within the battery pack.

Thus, battery cells (e.g., prismatic, pouch, and cylindrical battery cells) used inside electric vehicles are typically wrapped in PET film/tape for dielectric protection. Cooling plates utilized within battery boxes are also typically wrapped or laminated with PET or powder-coated for similar dielectric protection. Battery cells are also often bonded to one another and to the cooling plate with thermally conductive, electrically insulative adhesives/potting materials. It is desirable that these materials not debond to form a gap between the thermally conductive adhesive/potting material and the cell. When a gap forms, the potential for greater thermal impedance, and, therefore, thermal runaway exists.

More particularly, PET films for use in insulating battery cells can include a PET layer and a pressure sensitive adhesive (PSA) layer. In battery packs, the PSA layer can be in contact with a battery cell wall/substrate (e.g., aluminum, steel, a composite, etc.) of one battery cell and the PET layer can be in contact with a thermal management adhesive/potting material, which can itself be positioned directly adjacent to the PET layer of a second PET film coated battery cell. The use of PET films to insulate battery cells can involve semi-manual installation and can result in poor adhesion at high temperatures/humidity. Additionally, the low surface energy of PET makes it difficult to bond reliably. Conventionally, adhesive and potting material manufacturers try to enhance their adhesives to bond better to PET-wrapped cells. However, automobiles are subject to a number of shock events (e.g., potholes, speed bumps, accidents, etc.), and thus have numerous opportunities for poorly bonded battery cell components to debond and remove heat from the system.

Therefore, there is an ongoing need for additional dielectric coatings that can be used for coating/insulating battery cells and battery pack components, particularly those that can also make the manufacturing/assembly process faster and/or simpler.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

In some embodiments, the presently disclosed subject matter provides a curable coating comprising one or more acrylate monomers, a photoinitiator, a urethane prepolymer, a crosslinker, one or more adhesion promoters, and optionally one or more fillers and/or one or more additives. In some embodiments, the one or more acrylate monomers comprise a reactive diluent. In some embodiments, the reactive diluent comprises at least one of isobornyl acrylate, isooctyl acrylate, and methyl methacrylate (MMA).

In some embodiments, the photoinitiator comprises a UV-activated photoinitiator. In some embodiments, the urethane prepolymer comprises a polyether urethane diacrylate. In some embodiments, the crosslinker comprises dipentaerythritol hexacrylate (DPHPA). In some embodiments, the one or more adhesion promoters comprise at least one of glycidyl methacrylate, 2-hydroxyethylmethacylate acid (HEMA) phosphate, an epoxy-silane, and methacrylic acid (MAA).

In some embodiments, the curable coating further comprises an acid scavenger. In some embodiments, the acid scavenger is selected from the group comprising zinc phosphate, zinc oxide, and zinc molybdate. In some embodiments, the curable coating comprises one or more fillers. In some embodiments, the one or more fillers comprise an untreated hydrophilic fumed silica and/or treated hydrophobic fumed silica and/or nepheline syenite.

In some embodiments, the curable coating is a 100% solids coating. In some embodiments, the cured coating has a breakdown voltage at about 100 microns thickness of about 5 kilovolts (kV) to about 10 kV. In some embodiments, the cured coating remains adhesive after aging at 85° C. and 85% relative humidity for up to 1000 hours. In some embodiments, the cured coating is free from pin-holes, bubbles and comprises good edge coverage.

In some embodiments, the presently disclosed subject matter provides a battery cell or other battery component coated with a layer of dielectric coating, wherein the dielectric coating is the reaction product formed by curing a layer of a curable coating comprising one or more acrylate monomers, a photoinitiator, a urethane prepolymer, a crosslinker, one or more adhesion promoters, and optionally one or more fillers and/or one or more additives. In some embodiments, the layer of dielectric coating has a thickness of about 25 to about 200 microns.

In some embodiments, the presently disclosed subject matter provides a method of coating a substrate with a dielectric coating, the method comprising applying a layer of the curable coating to a surface of a substrate, wherein the curable coating comprises one or more acrylate monomers, a photoinitiator, a urethane prepolymer, a crosslinker, one or more adhesion promoters, and optionally one or more fillers and/or one or more additives; and exposing the curable coating to UV radiation, thereby forming a coated substrate. In some embodiments, the substrate comprises a metal surface, optionally wherein the metal is aluminum. In some embodiments, the substrate comprises a component of a battery cell or a battery pack.

In some embodiments, the method further comprises forming a battery component from the coated substrate.

In some embodiments, applying a layer of curable coating is performed by spray coating, roll coating, or dip coating. In some embodiments, the layer of curable coating has a thickness of about 25 microns to about 200 microns. In some embodiments, the UV radiation is supplied with a mercury lamp.

Accordingly, it is an object of the presently disclosed subject matter to provide a curable coating (e.g., a UV curable dielectric coating) and related methods and coated materials. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description and examples.

### BRIEF DESCRIPTION OF THE DRAWINGS

FIG. 1 is a schematic diagram of a battery cell assembly interface of two battery cells insulated with a dielectric coating formed as the reaction product of an ultraviolet (UV)-curable coating composition of the presently disclosed subject matter.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a component” includes a plurality of such components, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, mass, weight, thickness, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

As used herein the term “alkyl” refers to C₁₋₂₀ inclusive, linear (i.e., “straight-chain”), branched, or cyclic, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl, or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, arylamino, acyl, hydroxyl, aryloxyl, alkoxyl, alkylthio, arylthio, aralkyloxyl, aralkylthio, carboxyl, alkoxycarbonyl, oxo, and cycloalkyl. In some embodiments, there can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

“Alkoxyl” refers to an alkyl-O— group wherein alkyl is as previously described. The term “alkoxyl” as used herein can refer to, for example, methoxyl, ethoxyl, propoxyl, isopropoxyl, butoxyl, t-butoxyl, and pentoxyl. The terms “alkoxy” and “oxyalkyl” can be used interchangeably with “alkoxyl”.

The term “silyl” refers to groups comprising silicon atoms (Si).

The term “silane” refers to a molecule comprising a silicone atom.

As used herein, the terms “siloxy” and “silyl ether” refer to groups or compounds including a silicon-oxygen (Si—OR) bond and wherein R is an organic group, such as a substituted or unsubstituted alkyl or aryl group (i.e., methyl, ethyl, phenyl, etc.). In some embodiments, the terms refer to compounds comprising one, two, three, or four alkoxy, aralkoxy, or aryloxy groups bonded to a silicon atom. Each alkyloxy, aralkoxy, or aryloxy group can be the same or different.

The term “urethane” as used herein refers to compounds containing urethane groups (—NH—CO—O—).

As used herein, a “monomer” refers to a molecule that can undergo polymerization, thereby contributing constitutional units, i.e., an atom or group of atoms, to the essential structure of a macromolecule.

As used herein, a “macromolecule” refers to a molecule of high relative molecular mass, the structure of which comprises the multiple repetition of units derived from molecules of low relative molecular mass, e.g., monomers and/or oligomers.

An “oligomer” refers to a molecule of intermediate relative molecular mass, the structure of which comprises a small plurality (e.g., 2, 3, 4, 5, 6, 7, 8, 9, or 10) of repetitive units derived from molecules of lower relative molecular mass.

A “polymer” refers to a substance comprising macromolecules. In some embodiments, the term “polymer” can include both oligomeric molecules and molecules with larger numbers (e.g., >10, >20, >50, >100) of repetitive units. In some embodiments, “polymer” refers to macromolecules with at least 10 repetitive units.

A “copolymer” refers to a polymer derived from more than one species of monomer.

A “branch point” (or “junction point”) refers to a point on a polymer chain (e.g., a main chain) at which a branch is attached. A “branch,” also referred to as a “side chain,” “graft,” or “pendant chain,” is a monomeric, oligomeric or polymeric offshoot from a macromolecule chain. In some embodiments, the graft is added to a reactive group on the polymer main chain after polymerization of the polymer main chain. An oligomeric branch can be termed a “short chain branch,” whereas a polymeric branch can be termed a “long chain branch.”

A “chain” refers to the whole or part of a macromolecule, an oligomer, or a block comprising a linear or branched sequence of constitutional units between two boundary constitutional units, wherein the two boundary constitutional units can comprise an end group, a branch point, or combinations thereof.

A “main chain” or “backbone” refers to a linear chain from which all other chains are regarded as being pendant.

### II. UV Curable Insulative Coatings

In some embodiments, the presently disclosed subject matter provides a curable coating (e.g., a radiation curable coating) that forms a dielectric coating upon curing, wherein the dielectric coating has good adhesion and environmental resistance. In some embodiments, the radiation curable coating is an ultraviolet (UV) curable coating, e.g., that can cure within seconds of exposure to UV energy.

In some embodiments, dielectric coating is formed as the reaction/polymerization product of a free-radical or cationic polymerization of an acrylic resin. In some embodiments, the cured dielectric coating has comparable dielectric properties to PET and a high surface energy. The coating can have improved adhesion to metal substrates (e.g., aluminum) compared to PET films typically used as dielectric coatings for battery packs and/or improved adhesion following aging under dry and/or wet conditions (e.g., 85° C. at 85% relative humidity (RH)).

In some embodiments, the presently disclosed curable coating comprises: (i) one or more acrylate monomers; (ii) a photoinitiator; (iii) a urethane prepolymer; (iv) a crosslinker; and (v) one or more adhesion promoters. In addition, the curable coating can optionally include one or more fillers and/or one or more additives.

The term “acrylate monomer” as used herein refers to both acrylate monomers (e.g., alkyl acrylate monomers) and the corresponding methacrylate monomers. In some embodiments, the one or more acrylate monomers comprise at least two or at least three (or more) acrylate (or methacrylate) groups. Thus, in some embodiments, the acrylate monomer can be multifunctional. In some embodiments, one or more of the one or more acrylate monomers is a reactive diluent, i.e., a compound that can reduce the viscosity of the curable coating formulation and also react/polymerize during curing to become part of the cured coating. Acrylate monomers can be monofunctional or polyfunctional (e.g., di- or triacrylates).

In some embodiments, the one or more acrylate monomers are monofunctional alkyl acrylates or monofunctional methacrylates, i.e., compounds containing one acrylate or methacrylate group and an alkyl moiety. For instance, monofunctional alkyl acrylate monomers have the structure CH₂═CH—C(═O)—O—R, where R is alkyl; and monofunctional alkyl methacrylate monomers have the structure CH₂═C(CH₃)—C(═O)—O—R, wherein R is alkyl. In some embodiments, the alkyl moiety comprises between 1 and 20 carbon atoms. In some embodiments, the alkyl moiety comprises between 6 and 18 carbon atoms (i.e., 6, 7, 8, 9, 10, 11, 12, 13, 14, 15, 16, 17, or 18 carbon atoms). In some embodiments, the alkyl moiety comprises between 8 and 16 carbon atoms. The alkyl group can be either straight chain, branched, or cyclic.

Suitable acrylate monomers include, but are not limited to, hexyl acrylate; hexyl methacrylate; cyclohexylacrylate; cyclohexyl-methacrylate; 2-ethylhexyl acrylate; 2-ethylhexyl methacrylate; isooctyl acrylate; isooctyl methacrylate; octyl acrylate; octyl methacrylate; decyl acrylate; decyl methacrylate; isodecyl acrylate; isodecyl methacrylate; isobornylacrylate; isobornylmethacrylate; lauryl acrylate; lauryl methacrylate; stearyl acrylate; stearyl methacrylate. In some embodiments, the one or more acrylate monomers can be selected based on their effect on the glass transition temperature (Tg) of the cured coating, e.g., to balance or modify the hardness or flexibility of the cured coating. For example, adding isobornyl acrylate can increase Tg, thereby increasing hardness of the cured coating. Adding isooctyl acrylate can decrease Tg and increase the flexibility of the cured coating.

In some embodiments, the one or more acrylate monomers include a reactive diluent comprising at least one of isobornyl acrylate, isooctyl acrylate, and methyl methacrylate (MMA). In some embodiments, the one or more acrylate monomers comprise isobornyl acrylate and isooctyl acrylate. In some embodiments, the one or more acrylate monomers further comprise MMA.

In some embodiments, the one or more acrylate monomers comprise between about 30 weight % and about 90 weight % of the total curable coating composition. In some embodiments the one or more acrylate monomers comprise between about 40 weight % and about 50 weight % of the total curable coating composition (e.g., about 40, 41, 42, 43, 44, 45, 46, 47, 48, 49 or about 50 weight % of the total curable coating composition). In some embodiments, the one or more acrylate monomers comprise between about 44 weight % and about 47 weight % of the total curable coating composition.

Any suitable radiation-activated photoinitiator can be used. Suitable radiation-activated photoinitiators, for example, include compounds that react to form free radicals or cations when exposed to visible or UV light. In some embodiments, the photoinitiator is a UV-activated photoinitiator. Exemplary photoinitiators include, but are not limited to, benzophenones, acetophenone derivatives, such as alpha-hydroxyalkylphenylkenotes, benzoin alkyl ethers, and benzil ketals, monoacylphosphine oxides, and bisacylphophine oxides. Other suitable photoinitiators include mercaptobenzothiazoles, mercaptobenzooxazoles, and hexaryl bisimidazole. For example, the photoinitiator can be selected from the group including, but not limited to, 1-hydroxycyclohexyl phenyl ketone, 2-methyl-1-[4-(methylthio)phenyl]-2-morpholino propan-1-one, 2-benzyl-2-N,N-dimethylamino-1-(4-morpholinophenyl)-1-butanone, a combination of 50% by weight 1-hydroxy cyclohexyl phenyl ketone and 50% by weight benzophenone, 2,2-dimethoxy-2-phenyl acetophenone, a combination of 25% by weight bis(2,6-dimethoxybenzoyl-2,4-,4-trimethyl pentyl) phosphine oxide and 75% by weight 2-hydroxy-2-methyl-1-phenyl-propan-1-one, blends of BAPO plus an alpha hydroxy ketone, (2-hydroxy-2-methyl-1-phenyl-1-propane, a combination of 50% by weight 2,4,6-trimethylbenzoyldiphenyl-phosphine oxide and 50% by weight 2-hydroxy 2-methyl-1-phenyl-propan-1-one, mixed triaryl sulfonium hexafluoroantimonate salts, and mixed triaryl sulfonium hexafluorophosphate salts. In some embodiments, the photoinitiator is bis(2,4,6-trimethylbenzoyl)-phenylphosphineoxide (sold under the brand name Omnirad 819 by IGM Resins, Charlotte, N.C., United States of America).

In some embodiments, the photoinitiator can be present in an amount of about 0.1% to about 15% of the total weight of the curable coating composition. In some embodiments, the photoinitiator is present in an amount of about 1% to about 10% of the total weight of the curable coating composition. In some embodiments, the photoinitiator is present in an amount of about 3% of the total weight of the curable coating composition.

Suitable urethane prepolymers include urethane-containing oligomers having a polyester or polyether backbone. In some embodiments, the urethane prepolymer further comprises one or more acrylate or methacrylate groups or another group or groups that can react with an acrylate or methacrylate monomer. Thus, in some embodiments, the urethane prepolymer is multi-functional. In some embodiments, the urethane prepolymer is di- or tri-functional (e.g., is a di- or triacrylate). In some embodiments, the urethane prepolymer is a polyether urethane diacrylate. Suitable urethane prepolymers include, but are not limited to, Miramer PU2510 (Miwon Specialty Chemical Co. Ltd., Yongin-si, Korea) and Sartomer CN980 (Sartomer Americas, Exton, Pa., United States of America). In some embodiments, the urethane prepolymer is present in an amount of about 10 weight % to about 25 weight % based on the total weight of the curable coating composition. In some embodiments, the urethane prepolymer is present in an amount of about 15 weight % to about 20 weight % (e.g., about 15, 16, 17, 18, 19, or about 20 weight %) based on the total weight of the curable coating.

Suitable crosslinkers include multifunctional acrylate compounds, such as those containing three or more acrylate or methacrylate groups. In some embodiments, the crosslinker is the polyacrylated or methacrylated product of a polyol (i.e., the product formed by the esterification of a polyol with acrylic acid or methacrylic acid). Suitable crosslinkers include, but are not limited to, dipentaerythritol, trimethylolpropane triacrylate, trimethyolpropane trimethacrylate, trimethylol propane (EO)₃ triacrylate, pentaerythritol triacrylate, and pentaerythritol tetracrylate. In some embodiments, the crosslinker comprises or consists of dipentaerythritol hexacrylate (DPHPA). In some embodiments, the crosslinker is present in about 2 weight % to about 15 weight % based on the total weight of the curable coating. In some embodiments, the crosslinker is present in about 2 weight % to about 10 weight % based on the total weight of the curable coating. In some embodiments, the crosslinker is present in about 4 weight % to about 8 weight % based on the total weight of the curable coating. In some embodiments, the crosslinker is present in about 5 weight % to about 7 weight % based on the total weight of the curable coating.

In some embodiments, a thiol monomer can be included in the coating as a chain transfer agent, e.g., to accelerate radical curing. Suitable thiol monomers include, for example, but are not limited to, pentaerylthritol tetrakis (3-mercaptuobutylate), sold under trade name KARENZ MT™ PE1 from Showa Denko K.K. (Tokyo, Japan).

Any suitable adhesion promoter or promoters can be used. Suitable adhesion promoters include compounds having a group that can participate in a the polymerization/curing reaction (e.g., a radical curing reaction) and a group that adheres to metal or another type of substrate that the curable composition can be used to insulate. The group that participates in the curing reaction can be, for instance, vinyl, (meth)acrylate, or thiol. Groups that adhere to metal include hydroxy, acid (e.g., carboxylic, phosphoric or sulphonic acid), phosphates, zirconate, titanate and silane. Thus, adhesion promoters include, but are not limited to, (meth)acrylate functionalized carboxylic or phosphoric acids. Exemplary suitable adhesion promoters include hydroxyethyl(meth)acrylate, hydroxypropyl(meth)acrylate, di- or trialkoxy zirconates or titanates, vinyl trimethoxysilane, mercaptopropyltrimethoxysilane, isocyanotoalkyltrialkoxy-silanes, methacrylylalkyl trialkoxysilanes, amino alkyltrialkoxysilanes and epoxy alkyltrialkoxy silanes. Another suitable silane adhesion promoter is vinyltrimethoxysilane. Mercaptosilanes, such as mercaptopropyltrimethoxysilane and mercaptopropyltriethoxysilane, can also be used. Additional examples of suitable adhesion promoters include acrylic acid and methacrylic acid (MAA). In some embodiments, the one or more adhesion promoters comprise one or more of glycidyl methacrylate, 2-hydroxyethylmethacrylic acid phosphate (HEMA phosphate), MAA, and an epoxy silane. In some embodiments, the epoxy silane is gamma-glycidoxypropyltrimethoxy silane (sold under the tradename SILQUEST A-187™, Momentive Performance Materials, Waterford, N.Y., United States of America).

In some embodiments, the one or more adhesion promoters are present at about 0.1 weight % to about 15 weight %. In some embodiments, the one or more adhesion promoters are present at about 2 weight % to about 6 weight %.

In some embodiments, the curable coating can further include one or more additives, such as, but not limited to an acid scavenger, a colorant, or a defoamer. For example, in some embodiments, the one or more additives include an acid scavenger. In some embodiments, the acid scavenger comprises a zinc phosphate (such as Heucophus® ZPA from Heubach GmbH (Langelsheim, Germany)), zinc oxide, and/or zinc molybdate (such as LF Bowsei M-PSN from Kukuchi Color and Chemicals Corporation, (Tokyo, Japan)). In some embodiments, the acid scavenger comprises or consists of zinc phosphate.

In some embodiments, the curable coating further includes one or more fillers. Suitable fillers include, but are not limited to, fumed silica (e.g., treated hydrophobic or untreated hydrophilic fumed silica (such as those sold under the tradename CAB-O-SIL™, Cabot Corporation, Boston, Mass., United States of America)) and nepheline syenite. Thus, in some embodiments, the filler comprises or consists of untreated hydrophilic fumed silica, treated hydrophobic silica, and/or nepheline syenite.

The curable coating can be coated on a substrate of interest (e.g., a surface of a metal or composite substrate) using any suitable technique, e.g., spray coating, roll-coating or dip coating. In some embodiments, the curable coating is coated on a substrate using spray coating. In some embodiments, the curable coating can be coated on a substrate to a thickness of about 25 microns to about 200 microns (e.g., about 25, 30, 35, 40, 45, 50, 55, 60, 65, 70, 75, 80, 85, 90, 95, 100, 105, 110, 115, 120, 130, 140, 150, 175, or about 200 microns). In some embodiments, the curable coating has a thickness of about 80 microns to about 125 microns. Curing of the curable coating can be performed by exposing the curable coating to UV or visible radiation. In some embodiments the curable coating is exposed to UV radiation using a mercury lamp (e.g., using 1500 mJ/cm² of energy).

In some embodiments, the curable coating is a 100% solids coating, which as used herein, refers to a coating that has essentially the same thickness before curing as after coating. In some embodiments, the cured coating is free from pin-holes, bubbles and comprises good edge coverage to the substrate upon which it is coated, e.g., a battery pack component.

In some embodiments, the presently disclosed curable coating cures to form a dielectric coating that electrically insulates the substrate to which it is applied, for example a component of a battery pack. Because the chemistry is UV-cured, it can be sprayed, roll-coated, dipped, and cured in a matter of seconds, thereby ensuring it is a cost-effective means of manufacturing battery cells which are commonly made in high volumes. Unlike PET films, which are adhered via a pressure sensitive adhesive tape, the present UV cured coating chemically bonds to the surface of the battery component, providing better adhesion and therefore reduced threat of thermal impedance, while providing similar or better dielectric properties. Additionally, the present coating provides for surrounding chemistries, such as those of thermal gap fillers, to bond to the UV-cured coating more robustly, also reducing or eliminating the risk of delamination and minimizing the threat of thermal impedance between the various layers of materials.

Thus, the UV curable coating of the presently disclosed subject matter has several advantages, particularly when used for insulating and protecting battery pack components. For example, the one-part (1K) 100% solids coating can be spray applied and provides good edge coverage for coated components, good adhesion after aging in wet conditions (85 C, 85% RH for 100, 250, 500, or 1000 hours). In some embodiments, the cured coating remains adhesive (e.g., has average Class 1 adhesion according to ISO 2409) after aging at 85° C. and 85% relative humidity for up to 1000 hours. Additionally, the coatings of the embodiments of the present invention provide good voltage breakdown protection. In some embodiments, the cured coating has a breakdown voltage at about 100 microns thickness of about 5 kilovolts (kV) to about 10 kV. In some embodiments, the cured coating has a breakdown voltage at about 100 microns thickness of about 8 kV to about 10 kV. Table 1 below summarizes example advantages of the UV dielectric coatings formed from the presently disclosed UV curable coatings compared to PET films.

TABLE 1
Comparison of UV dielectric coating and PET film

| | PET film | UV Dielectric coating |
|---|---|---|
| Function | Dielectric protection | Dielectric protection |
| Adhesion | Pressure sensitive | Covalent chemical bonds |
| method | adhesive (wetting | |
| | and Van der Waals) | |
| Adhesion | Low | High |
| strength | | |
| Form | Solid film | Liquid |
| Application | Pressure roll | Spray, dip, or roll coat |
| method | | |
| Curing method | None | Fast UV initiated radical |
| | | polymerization |

In some embodiments, the subject matter disclosed herein provides a substrate coated with a layer of a dielectric coating, wherein the dielectric coating is the reaction product of curing (e.g., UV curing) a layer of a presently disclosed curable coating. In some embodiments, the substrate is a metal substrate or a composite substrate. In some embodiments, the coated substrate is a battery cell or other battery component (e.g., a part of a battery assembly, such as for use in an electric vehicle).

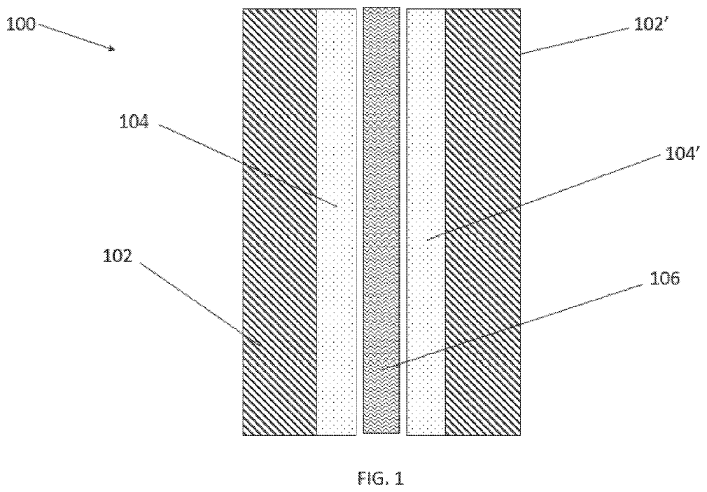

As an example, in some embodiments, the UV curable coating can be coated onto at least one side of a battery cell exterior surface to provide a coated battery cell. In some embodiments, the coated battery cell is part of a battery cell assembly or battery pack. For instance, FIG. 1 illustrates battery cell assembly interface 100 between two battery cells insulated using the presently disclosed dielectric coating (e.g., in place of a PET film). In battery cell assembly interface 100, a first battery cell substrate 102 (e.g., aluminum or another metal or a composite material) is coated with dielectric coating 104 formed as the reaction product of a UV curable coating of the presently disclosed subject matter. A second battery cell substrate 102′ is coated with dielectric coating 104′, also formed as the reaction product of a UV curable coating of the presently disclosed subject matter. Disposed between the two dielectric coated battery cell substrates is thermal management adhesive/potting material layer 106.

In some embodiments, the substrate coated with the presently disclosed coating is a material that can be used to form part of a battery cell after the coating is applied and cured. For example, in some embodiments, the substrate is a metal (e.g., Al) coil.

In some embodiments, the layer of the dielectric coating has a thickness of between about 25 microns and about 200 microns. In some embodiments, the dielectric coating has a thickness of about 80 microns to about 125 microns. In some embodiments, the layer of dielectric coating remains adhesive (e.g., has average Class 1 adhesion according to ISO 2409) after aging under wet or dry conditions, e.g., at 85° C. and 85% relative humidity for up to 1000 hours. In some embodiments, the dielectric coating has a breakdown voltage at about 100 microns thickness of about 5 kV to about 10 kV. In some embodiments, the dielectric coating has a breakdown voltage at about 100 microns of about 8 kV to about 10 kV.

In some embodiments, the presently disclosed subject matter provides a method of coating a substrate with a dielectric coating. In some embodiments, the method comprising applying a layer of the presently disclosed curable coating (e.g., a UV curable coating comprising one or more acrylate monomers, a photoinitiator, a urethane prepolymer, a crosslinker, one or more adhesion promoters, and optionally one or more fillers and/or one or more additives) to a surface of a substrate; and exposing the curable coating to UV radiation, thereby forming a coated substrate. In some embodiments, the substrate comprises a metal surface. For example, the metal can be aluminum or steel. In some embodiments, the substrate comprises a component of a battery cell or a battery pack. Alternatively, in some embodiments, the substrate can be a material intended for use in producing a battery component. For example, the substrate can comprise a metal sheet or coil (e.g., an Al coil). Thus, in some embodiments, the method can further comprise forming a battery component from the coated substrate.

The layer of curable coating can be applied via any suitable technique. In some embodiments, the applying is performed by spray coating, roll coating, or dip coating. In some embodiments, the applying is performed by spray coating. In some embodiments, the layer of curable coating has a thickness of about 25 microns to about 200 microns (e.g., about 25, 30, 35, 40, 45, 50, 55, 60, 65, 70, 75, 80, 85, 90, 95, 100, 105, 110, 115, 120, 125, 130, 140, 150, 160, 175 or about 200 microns). In some embodiments, the layer of curable coating has a thickness of about 80 microns to about 125 microns. In some embodiments, the UV radiation is supplied with a mercury lamp.

### Examples

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

Curable coatings were prepared according to the formulations described below in Table 2 and spray applied to an aluminum substrate (3003) from Q-Lab Corporation (Westlake, Ohio, United States of America) for testing. The coatings were applied at a film thickness of 80-125 microns (μm) as measured with Fischer scope model dualscope FMP40C (Fisher Technology Inc., Windsor, Conn., United States of America). The coatings were then cured with a mercury lamp (H+ bulb) at 1500 millijoules per square centimeter (mJ/cm²) as measured using a radiometer, such as the radiometer sold under the tradename UVICURE Plus II (EIT, Sterling, Va., United States of America).

The resulting cured coatings observed to have no pin holes, no bubbles, and very good edge coverage. Further properties of the coatings were measured and are reported in Table 2 below. The same properties were measured for standard PET film for comparison purposes.

TABLE 2
Coating formulations and cured coating properties.

| Material | Primary Function | PET film | Example 1 | Example 2 |
|---|---|---|---|---|
| Isobornyl | Reactive diluents, | | 45 | 35.9 |
| acrylate, isooctyl | high Tg for | | | |
| acrylate | hardness, low Tg | | | |
| | for flexibility | | | |
| MMA | Reactive diluents, | | | 10 |
| | high Tg | | | |
| Omnirad 819 | Photoinitiator | | 3 | 3 |
| Polyether | Film former for | | 19.3 | 16.9 |
| Urethane | mechanical | | | |
| diacrylate | properties | | | |
| Dipentaerythritol | Crosslinker for | | 6.4 | 5.0 |
| hexacrylate | mechanical | | | |
| | properties | | | |
| Glycidyl-MA, | Adhesion | | 8 | 10.5 |
| HEMA phos, | promoters | | | |
| MAA, epoxy | | | | |
| silane | | | | |
| Untreated/treated | Viscosity booster, | | 17.5 | 14.9 |
| fumed silica; | reinforcing filler | | | |
| nepheline | | | | |
| syenite | | | | |
| Acid Scavenger | additives | | 0.8 | 3.8 |
| defoamer, | | | | |
| colorant | | | | |
| Properties | Measurement Method | | | |
| Breakdown | Hipot tester (3- | 4.1 kV @ | 8-10 kV@ | >6 kV@ |
| Voltage (kV) | 6 kV, 7 sec, 0.1 | .043 mm | 0.11 mm** | 0.11 mm |
| | mAmp limit) or | 8 kV@ | | |
| | ASTM D149** | 0.084 mm** | | |
| Volume | ASTM D257-14 | 7.1 × 10¹⁵ | 3 × 10¹⁴ | ~10¹⁴ |
| Resistivity | | | | |
| (ohm-cm) | | | | |
| Initial Viscosity | Brooksfield | n/a | 1200 cP | 3750 cP |
| (cP) | Viscometer | | | |
| Primary | ISO 2409 | Class 4 | Class 0 | Class 0 |
| Adhesion to | (crosshatch) | (fail) | (pass) | (pass) |
| Aluminum 3003 | | | | |
| Adhesion after | ISO 2409 | Class 4 | Class 1 | Class 1 |
| 100 h at | | (fail) | (pass) | (pass) |
| 85 C./85RH | | | | |
| Adhesion after | ISO 2409 | Class 4 | Class 1 | Class 1 |
| 500 h at | | (fail) | (pass) | (pass) |
| 85 C./85RH | | | | |
| Adhesion after | | n/a | Class 1 | Class 1 |
| 1000 h at | | | (pass) | (pass) |
| 85 C./85RH | | | | |
| Edge Coverage | Visual and film | n/a | OK | Good |
| | thickness | | | |
| Flexibility | Bending of coated | Pass | Pass | Pass |
| | specimens on axle | | | |
| | bars of different | | | |
| | diameters: bending | | | |
| | test of axle bars | | | |
| | with 9 mm | | | |
| | curvature radius | | | |

It will be understood that various details of the presently disclosed subject matter can be changed without departing from the scope of the presently disclosed subject matter. Furthermore, the foregoing description is for the purpose of illustration only, and not for the purpose of limitation.

1. A curable coating comprising one or more acrylate monomers, a photoinitiator, a urethane prepolymer, a crosslinker, one or more adhesion promoters, and one or more fillers, wherein the one or more fillers comprises fumed silica.

2. The curable coating of claim 1, wherein the one or more acrylate monomers comprise a reactive diluent.

3. The curable coating of claim 2, wherein the reactive diluent comprises at least one of isobornyl acrylate, isooctyl acrylate, and methyl methacrylate (MMA).

4. The curable coating of claim 1, wherein the photoinitiator comprises a UV-activated photoinitiator.

5. The curable coating of claim 1, wherein the urethane prepolymer comprises a polyether urethane diacrylate.

6. The curable coating of claim 1, wherein the crosslinker comprises dipentaerythritol hexacrylate (DPHPA).

7. The curable coating of claim 1, wherein the one or more adhesion promoters comprise at least one of glycidyl methacrylate, 2-hydroxyethylmethacylate acid (HEMA) phosphate, an epoxy-silane, and methacrylic acid (MAA).

8. The curable coating of claim 1, further comprising an acid scavenger.

9. The curable coating of claim 8, wherein the acid scavenger is selected from the group consisting of zinc phosphate, zinc oxide, and zinc molybdate.

10. (canceled)

11. The curable coating of claim 1, wherein the one or more fillers comprises an untreated hydrophilic fumed silica, treated hydrophobic fumed silica, and/or nepheline syenite.

12. The curable coating of claim 1, wherein the coating is a 100% solids coating.

13. The curable coating of claim 1, wherein the cured coating has a breakdown voltage at about 100 microns thickness of about 5 kilovolts (kV) to about 10 kV.

14. The curable coating of claim 1, wherein the cured coating remains adhesive after aging at 85° C. and 85% relative humidity for up to 1000 hours.

15. The curable coating of claim 1, wherein the cured coating is free from pin-holes and/or bubbles.

16. A battery cell or other battery component coated with a layer of dielectric coating, wherein the dielectric coating is a reaction product formed by curing a layer of a curable coating of claim 1.

17. The battery cell or other battery component of claim 16, wherein the layer of dielectric coating has a thickness of about 25 microns to about 200 microns.

18. A method of coating a substrate with a dielectric coating, the method comprising applying a layer of the curable coating of claim 1 to a surface of a substrate; and exposing the curable coating to UV radiation, thereby forming a coated substrate.

19. The method of claim 18, wherein the substrate comprises a metal surface, and/or wherein the metal is aluminum.

20. The method of claim 19, wherein the substrate comprises a component of a battery cell or a battery pack.

21. The method of claim 19, further comprising forming a battery component from the coated substrate.

22. The method of claim 18, wherein applying a layer of curable coating is performed by spray coating, roll coating, or dip coating.

23. The method of claim 18, wherein the layer of curable coating has a thickness of about 25 microns to about 200 microns.

24. The method of claim 18, wherein the UV radiation is supplied with a mercury lamp.

25. A curable coating comprising one or more monomers, a photoinitiator, a urethane prepolymer, a crosslinker, one or more adhesion promoters, and one or more reinforcing fillers.
